(19) United States
(12) Patent Application Publication
(10) Pub. No.: US 2004/0226891 A1
(43) Pub. Date: Nov. 18, 2004

(54) Chemical treatment for control of sulfide odors in waste materials

(76) Inventor: Steven K. Dentel, Newark, DE (US)

Correspondence Address: CONNOLLY BOVE LODGE & HUTZ LLP, SUITE 800, 1990 M STREET NW, WASHINGTON, DC, 20036-3425, US

(21) Appl. No.: 10/798,830

(22) Filed: Mar. 12, 2004

Related U.S. Application Data
(60) Provisional application No. 60/453,497, filed on Mar. 12, 2003.

(51) Int. Cl. C02F 1/52

(52) U.S. Cl. 210/722; 210/749; 210/916

(57) ABSTRACT

Disclosed herein is a process for removing odorants from a waste system comprising treating said waste system with ferric nitrate at a ratio of less than 2.4 parts nitrate oxygen for each 1 part reduced sulfur.

### CROSS-REFERENCE TO RELATED APPLICATIONS

This application claims priority under 35 USC 119(e) to U.S. Ser. No. 60/453,497 filed Mar. 12, 2003, the content of which is incorporated herein by reference in its entirety.

### BACKGROUND OF THE INVENTION

1. Technical Field of the Invention

The present invention relates generally to treatments for wastewater and sludge and in particular to treatments of wastewater for odor control purposes.

2. Description of Related Art

Odor is a significant problem in sewage and in sewage sludges, as well as in other waste flows and waste materials. Odorants such as hydrogen sulfide and other reduced sulfur forms such as dimethyl disulfide, dimethyl sulfide, and methane thiol can impair the ability to treat, transport, or dispose of such waste matter. For example, more than half of all such sludges in the United States are disposed of by application to agricultural land, and while this practice is environmentally and economically acceptable in many respects, the odors generated have led to local bans. The use of an improved additive for odor minimization could alleviate this problem. Similar issues are present in the context of sewage treatment plants and odorous animal manures.

Some previous approaches to odor control have recognized the use of certain nitrates, such as U.S. Pat. No. 3,300,404 which recommends the specific use of ammonium nitrate or nitric acid in waste treatment, and U.S. Pat. No. 6,309,597 which suggests the use of polycyclic quinone compounds combined with metal nitrates. U.S. Pat. No. 4,911,843 requires a ratio of at least 2.4 parts nitrate oxygen (NO₃—O) for each 1 part dissolved sulfide for odor control. In a second approach to odor control, certain theories have invoked the use nitric acid or combinations thereof with other strong acids such as sulfuric acid (U.S. Pat. Nos. 4,108,771 and 4,446,031). In either case, the presence of these acids is detrimental. Specifically, the acidity of the treated waste is a disadvantage because it may impair the biodegradation processes that are desired in many circumstances, or increase the leachability of certain heavy metals, if the pH after treatment is too low, e.g. less than 6.5. The result of such conditions is to make the disposal of the waste more problematic. When the final pH is even more acidic, i.e. less than 2.0, the treated material will be classified as a hazardous waste and will be quite costly to dispose of. Consequently, the use of odor control treatments that include strong acids mean that additional treatments are needed in order to dispose of the material, adding to the cost and complexity of the process(es) involved. For example, U.S. Pat. Nos. 4,446,031, 4,888,404, 6,217,768 and 4,911,843 describe certain treatments of sewage and/or wastewater utilized by those of skill in the art.

In some cases, suggestions have generally been made to combine active reagents that include ferric ions from certain iron salts in acidic solution for odor control. For example, Adam Prescott of Kemro Chemicals (UK), Ltd, Kemwater, described in The Water Mirror, No. 1, January 2003 that nitrate salts act as an alternative oxygen source to ensure the presence of anoxic bacteria to prevent the development of anaerobic microorganisms. He further mentioned the use of iron nitrate. However, the use of these ferric ions in an acidic combination is undesirable for the reasons given above.

### SUMMARY OF THE INVENTION

The invention is a new process by which ferric nitrate is used for odor control. By use of this specific additive, less nitrate is required because the ferric ion also removes sulfide. The present invention, contrary to the above suggestions, avoids an acidic environment. The improved and beneficial effects of the present invention can be realized without acidification of the sewage, sludge, or other sample to be treated.

A further object of the present invention is directed to acid-free or acid-reduced treatments suitable for use with wastewater and/or sludge and/or sewage. By acid-free, the applicant intends that less than 5%, preferably less than about 3%, most preferably less than about 1% or even less than 0.5% of the treatment material added to the sludge or wastewater is in acid form. By acid reduced, the applicant intends that the additives contain up to 100% less acid than those typically utilized in the prior art. In some cases, there will be a reduction of at least 5-10% acid content as compared with those treatments typically employed.

The present invention is further directed to systems including mobile or stand-alone, as well as stationary or integrated systems that can be employed to treat wastewater, such as sewage or sludge from any desired location and in a convenient way to reduce complexities associated with transport and/or maintenance of facilities.

Further included as part of the present invention are methods of preparation, mixing, and usage of systems and treatments according to the present invention.

Additional objects, features and advantages of the invention will be set forth in the description which follows, and in part, will be obvious from the description, or may be learned by practice of the invention. The objects, features and advantages of the invention may be realized and obtained by means of the instrumentalities and combination particularly pointed out in the appended claims.

### BRIEF DESCRIPTION OF THE DRAWINGS

FIG. 1 is a diagram showing a process according to one embodiment of the present invention.

### DETAILED DESCRIPTION OF A PREFERRED EMBODIMENT

Prior attempts to employ ferric ions in odor control applications required that of at least 2.4 parts nitrate oxygen (NO₃—O) for each 1 part dissolved sulfide be employed. Such ratios are unacceptable in many applications. It has unexpectedly been found in connection with the present invention that ferric ions can reduce the nitrate requirement below the ratio of 2.4 parts nitrate oxygen to 1 part sulfide. In fact in the present invention, it is possible to employ ratios of from 1.5 to 2.4, preferably 1.5 to 2.3, more preferably from 1.6 to 2.0. This is based on the calculated reaction amounts achieved by combining the oxygen-donor ability of the nitrate, with the reactions due to the ferric iron. The ferric iron acts both as an election acceptor and a sulfide precipitant in providing these effects.

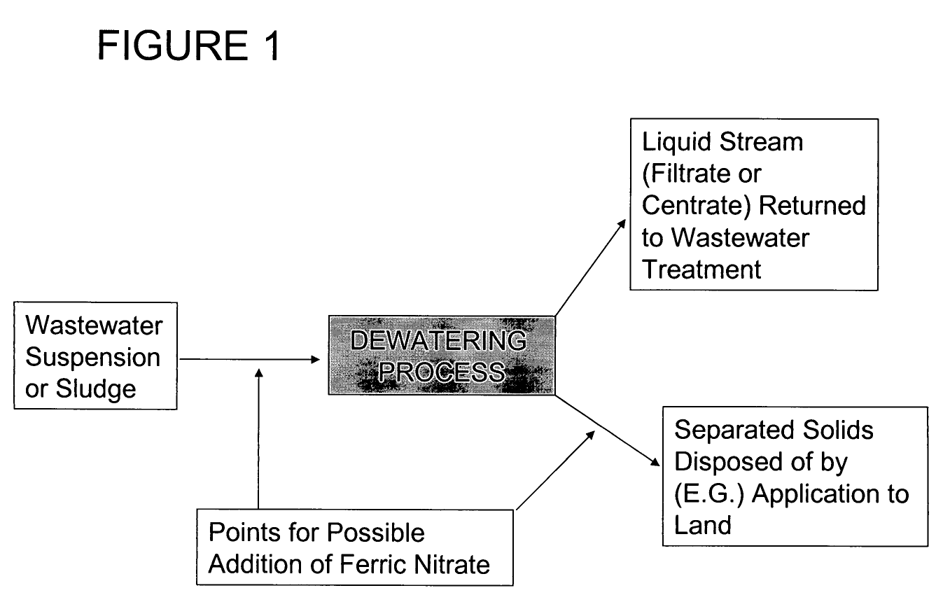

A further advantage of the present invention is that ferric nitrate may be substituted for the ferric chloride or ferric sulfate often used in wastewater and sludge treatment processes for coagulation of suspended solids, for precipitation of phosphorus, or occasionally for odor control. With this substitution, the favorable effects of the ferric ion are maintained, with the added benefit of odor control through use of ferric nitrate. As shown in FIG. 1, the application of ferric nitrate can be at numerous points during wastewater or sludge treatment. For example, it could be added before dewatering. Alternatively, ferric nitrate (or just ferric ions) could be added to the separated solids that contain the odorous sulfide.

The use of ferric nitrate and/or the presence of ferric iron as disclosed herein to reduce the amount of sulfide in sludge or other waste systems is believed to be unexpected in view of the prior teachings in the industry. Namely, by employing ratios of ferric nitrate and/or ferric iron to sulfide in a ratio of from 1.5 to 2.4, advantageously 1.5-2.3, and even more advantageously in a ratio of from 1.6 to 2.0, gas production of hydrogen sulfide is reduced to below detectable levels when this is not achieved by the application of ferric chloride.

Treatments of the present invention are preferably acid free, or at least acid-reduced. By acid-free, the applicant intends that less than 5%, preferably less than about 3%, most preferably less than about 1% or even less than 0.5% of the treatment material added to the sludge or wastewater is in acid form. By acid reduced, the applicant intends that the additives contain up to 100% less acid than those typically utilized in the prior art. In some cases, there will be a reduction of at least 5-10% acid content as compared with those treatments typically employed.

A suitable chemical treatment composition for adding to wastewater is as follows:

preferably about 65-75% iron nitrate;

preferably about 25-35% other material(s).

The other materials can be any desired or known to those of skill in art. In one embodiment, the additional materials comprise lime as CaO. In other embodiments the other materials may be formulated if desired with other alkaline or buffering materials having approximately the same neutralizing capability as lime. The chemicals may be combined as a formulation prior to addition or alternatively, may be added separately but in the same mixing process.

The components of chemical treatment composition are based on the total weight of the composition.

Another suitable formulation comprises:

preferably about 65-75% iron nitrate;

preferably 25-35% sodium hydroxide as NaOH, added in liquid form as a solution of 1-10% NaOH by weight.

Another possible formulation comprises;

preferably about 40-50% iron nitrate, and preferably about 50-60% other material(s) (e.g. sodium bicarbonate (s)).

Compositions of the present invention are generally added in amounts of from 1-5%, to wastewater, preferably from 1-4%, most preferably from 2-4%, each percentage based on the total weight of the solids in the wastewater (excluding the weight of liquids). The addition based on solids and liquids will vary according to the solids concentration in the liquid or sludge as indicated in FIG. 1. Compositions of the present invention are unexpectedly superior to those of the prior art.

The present invention is further directed to systems including mobile or stand-alone, as well as stationary or integrated systems that can be employed to treat wastewater, such as sewage or sludge from any desired location and in a convenient way to reduce complexities associated with transport and/or maintenance of facilities.

Such systems include mobile units that include tanks that can be driven or wheeled or transported in any desired manner to a site sought to be treated. Such mobile units can include, for example, hoses, dispensers, gauges, filters, one or more tanks, mixing units, stirrers, as well as other components. The chemicals of the composition to be added to the wastewater can be housed in one or more tanks and mixed ahead of time or on site, whichever is desired. In the case of addition to a dewatered sludge as indicated in FIG. 1, a mixing system can also be included if desired to assist and/or assure uniform addition of the chemical formulation to the sludge.

The present invention is also adaptable to systems that are not mobile, but to which wastewater is directed toward and cleaned/treated therein. Furthermore, systems of the present invention can be implemented into already existing systems as a further treatment regime in addition to treatments already being utilized.

Treatments and compositions of the present invention are not limited to use with municipal wastewater, but also can be utilized with other aqueous or solid materials if desired for any reason. For example, other waste streams can be treated such as food wastes or industrial waste streams, landfill leachate, or animal manures, as well as others. Compositions and treatments of the present invention permit treatment of many environments that were not easily or readily treated by prior systems. This is due to the fact the present invention preferably utilized acid-free or at least acid-reduced compositions.

Further included as part of the present invention are methods of preparation and usage of systems and treatments according to the present invention.

Such methods include treating wastewater or other material by introducing ferric nitrate and/or ferric ions to wastewater or other material in the absence of an acidic environment, conducting a dewatering operation, separating solids from said wastewater to produce a liquid portion and a solid portion, and returning the liquid portion to the original material (e.g. wastewater).

The following examples are set forth as illustrative and not limiting to the present invention.

### EXAMPLE

Anaerobically digested sludge was incubated at 35 degrees C. for 13 days in 100-mL sealed glass bottles. One bottle contained the plain sludge, while another contained sludge to which 1200 mg/L ferric chloride was added, and another the same amount of ferric nitrate. In order to increase the generation of odors, the 50 mL of sludge in each bottle was supplemented with 25 mL of a solution containing sodium chloride and the amino acids cysteine and methionine. Gas production was measured by periodic measurements of volume displacement, which were summed. Gas compositions were measured by solid phase microextraction from the head space followed by GC/MS analysis. Gas compositions are indicated as relative amounts based on maximum observed peak area during the experimental period.

| Sample | Total gas production, mL | Maximum H₂S |
|---|---|---|
| Plain undosed | 17.4 | 99,000 |
| Ferric chloride-dosed | 22.2 | 3,500 |
| Ferric nitrate-dosed | 15.3 | ND |

Additional advantages, features and modifications will readily occur to those skilled in the art. Therefore, the invention in its broader aspects is not limited to the specific details, and representative devices, shown and described herein. Accordingly, various modifications may be made without departing from the spirit or scope of the general inventive concept as defined by the appended claims and their equivalents.

All documents referred to herein are specifically incorporated herein by reference in their entireties.

As used herein and in the following claims, articles such as “the”, “a” and “an” can connote the singular or plural.

What is claimed is:

1. A process for removing odorants from a waste system comprising treating said waste system with ferric nitrate at a ratio of less than 2.4 parts nitrate oxygen for each 1 part reduced sulfur.

2. A process according to claim 1, wherein said odorants comprise one or more selected from the group consisting of hydrogen sulfide and reduced sulfur materials.

3. A method for treating wastewater comprising:
introducing ferric nitrate and/or ferric ions to said wastewater in the absence of an acidic environment,
conducting a dewatering operation,
separating solids from said wastewater to produce a liquid portion and a solid portion, and
returning said liquid portion to said wastewater.

4. A method according to claim 1, wherein said ratio is from 1.5 to 2.4.

5. A method according to claim 1, wherein said ratio is from 1.5-2.3.

6. A method according to claim 1, wherein said ratio of from 1.6 to 2.0.

7. A composition suitable for treating wastewater comprising:
at least about 40% by weight ferric nitrate and/or a source of ferric ions
up to about 60% by weight of an alkaline or buffering material, said percentages being based on the weight of said composition.

8. A composition according to claim 7, wherein said alkaline or buffering material comprises lime or sodium hydroxide.

9. A composition according to claim 7, wherein said ferric nitrate or ferric ion source is present in an amount from about 65-about 75% by weight based on the total weight of the composition.

10. An acid-reduced system suitable for treating a material sought to be treated comprising:
A least one tank containing ferric nitrate,
At least one means for delivering said ferric nitrate to said material

11. A system of claim 10 wherein said system is mobile.

12. A system of claim 10 wherein said system is integrated into an existing arrangement.

13. A system of claim 10, wherein said system is stationary.

14. A system of claim 10, wherein said at least one tank comprises a composition comprising: at least about 40% by weight ferric nitrate and/or a source of ferric ions, and up to about 60% by weight of an alkaline or buffering material, said percentages being based on the weight of said composition.

15. A system of claim 10, wherein said material comprises wastewater, sludge and/or sewage.
